(19) United States
(12) Patent Application Publication
(10) Pub. No.: US 2013/0134264 A1
(43) Pub. Date: May 30, 2013

(54) Electric Motor Powered Rotor Drive for Slowed Rotor Winged Aircraft

(71) Applicants: Jay W. Carter, JR., Burkburnett, TX (US); Jeffrey R. Lewis, Wichita Falls, TX (US)

(72) Inventors: Jay W. Carter, JR., Burkburnett, TX (US); Jeffrey R. Lewis, Wichita Falls, TX (US)

(73) Assignee: Carter Aviation Technologies, LLC, Wichita Falls, TX (US)

(21) Appl. No.: 13/445,594

(22) Filed: Apr. 12, 2012

Related U.S. Application Data
(63) Continuation-in-part of application No. 13/305,441, filed on Nov. 28, 2011.

(51) Int. Cl. B64C 27/22; B64C 9/00; B64D 35/00; B64C 27/26; B64C 27/28

(52) U.S. Cl. 244/7 A; 244/6

(57) ABSTRACT

A rotor aircraft has an engine, a propeller, wings, and a rotor. An electric motor is coupled to the rotor drive shaft for applying torque to the rotor drive shaft. The electric motor is sized to supply all of the torque to pre-rotate the rotor to a selected speed prior to liftoff of the aircraft. The wings are capable of providing substantially all of the lift required during forward flight at a cruise speed. The rotor being is capable of being trimmed to provide substantially zero lift and auto-rotate at cruise speed. Sensors sense flight conditions of the aircraft and provide signals to a controller that selectively causes the electric motor to cease applying torque to the rotor drive shaft during autorotation at cruise speed. The controller also causes the electric motor to apply torque to the rotor drive shaft if the sensors indicate additional rotor speed is needed.

### CROSS REFERENCE TO RELATED APPLICATION

This application is a continuation-in-part of Ser. No. 13/305,441, filed Nov. 28, 2011.

### FIELD OF THE INVENTION

This invention relates in general to an aircraft having a rotor for providing lift for take off and landing, and wings for providing lift at cruise flight speeds, the aircraft having an electric motor for selective rotation of the rotor.

### BACKGROUND

A type of slowed rotor aircraft, sometimes called a gyroplane, is illustrated in U.S. Pat. No. 5,727,754. The aircraft has a rotor similar to a helicopter blade rotor. The aircraft has a propeller that provides forward thrust, and wings for providing substantially all of the lift in cruise flight. The rotor blades have weighted tips to create inertia. The aircraft in the '754 patent will perform a jump takeoff by rotating the rotor at a speed higher than that needed for steady state flight while the collective pitch is at zero and the landing gear brakes on. The propeller is also rotated prior to takeoff. The collective pitch of the rotor and propeller are then increased to a takeoff level and the brakes released, which causes the aircraft to lift. A clutch disengages the engine from the rotor at the moment of takeoff, but the inertia of the rotor continues spinning the rotor after liftoff.

As the aircraft accelerates forward and the rotor rpm decays, the rotor is tilted back relative to the airstream, causing the rotor to auto-rotate. The auto-rotation of the rotor occurs due to the airstream passing through the rotor blades. As the aircraft gains forward speed, the wings will begin providing a greater portion of the lift required to maintain the aircraft in flight. As the aircraft forward flight speed increases further, the wings will provide substantially all of the lift, at which point the rotor collective pitch will have been reduced to at or near zero. The rotor rpm will be maintained at a slow rate by tilting the rotor relative to the fuselage.

### SUMMARY

The rotor aircraft described herein has an engine and a propeller driven by the engine to provide forward thrust to the aircraft. Wings provide lift while in forward flight. A rotor having a rotor drive shaft is mounted for selectively providing lift. An electric motor selectively applies torque to the rotor drive shaft. At least one rudder is positioned within a prop blast region of the propeller. The rudder is sized to counter torque applied by the electric motor to the rotor drive shaft while the aircraft is airborne.

The electric motor may comprise the sole source for applying torque to the rotor drive shaft. Alternately, a clutch may be connected between the engine and the rotor drive shaft for selectively engaging and disengaging the engine from the rotor drive shaft. The clutch is located such that the electric motor is able to supply torque to the rotor drive shaft while the clutch is disengaged.

The electric motor may be sized to supply all of the torque to pre-rotate the rotor to a selected liftoff rotational speed prior to liftoff of the aircraft. If so, a clutch between the engine and the rotor drive shaft may not be needed. Alternately, the electric motor may be sized to pre-rotate the rotor prior to lift off to a selected fraction of a pre-rotation liftoff speed while the clutch is disengaged. When reaching the selected fraction, the clutch may be engaged to enable the engine to apply torque to the rotor drive shaft to reach the pre-rotation liftoff speed.

The aircraft has sensors for sensing flight conditions of the aircraft. A controller controls the electric motor while the aircraft is airborne in response to input from the sensors. The wings are capable of providing substantially all of the lift required during forward flight at a cruise speed. The rotor is capable of being positioned to provide substantially zero lift and auto-rotate due to air flowing through the rotor at the cruise speed. The controller may cause the electric motor to cease applying torque to the rotor drive shaft during autorotation at cruise speed. The controller may cause the electric motor to apply torque to the rotor drive shaft during flight if the sensors indicate additional rotor speed is needed.

### BRIEF DESCRIPTION OF THE DRAWINGS

FIG. 1 is a top view of a slowed rotor winged aircraft in accordance with this disclosure.

FIG. 2 is a schematic illustrating the principal drive components for the propeller and the rotor of the aircraft of FIG. 1 and employing an electric motor to apply torque to the rotor drive shaft.

FIG. 3 is a schematic similar to FIG. 2, but illustrating an alternate embodiment wherein the engine is also coupled to the rotor drive shaft to apply torque to the rotor drive shaft.

### DETAILED DESCRIPTION

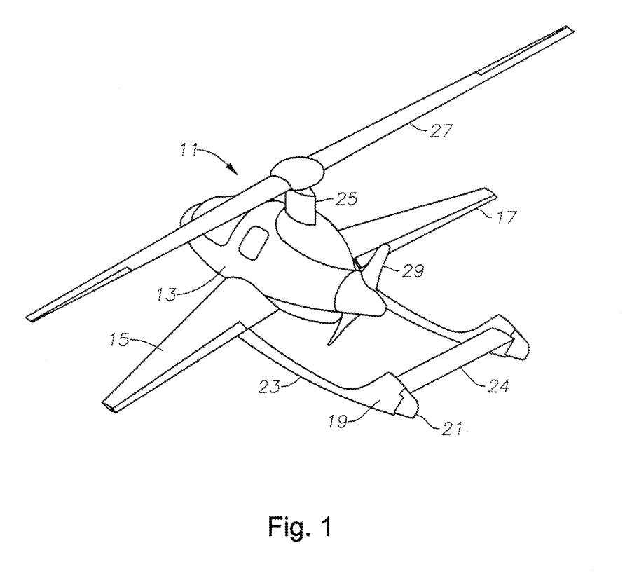

Referring to FIG. 1, aircraft 11 has a fuselage 13. A pair of high aspect ratio wings 15 extends outward from fuselage 13. The length of each wing 15 over the chord between the leading edge and trailing edge is quite high so as to provide efficient flight at high altitudes. Wings 15 preferably have ailerons 17 that extend from the tip to more than half the distance to fuselage 13. Each aileron 17 has a width that is about one-third the chord length of wing 15 and is moveable from a level position to a full ninety degrees relative to the fixed portion of each wing 15.

Aircraft 11 also has a pair of vertical stabilizers 19, each of which has a moveable rudder 21. Each vertical stabilizer 19 is mounted on a separate boom or tail portion 23 extending aft of fuselage 13. An elevator 24 extends between vertical stabilizers 19.

A rotor mast 25 extends upward from fuselage 13 and supports a rotor 27, which comprises at least two blades. Preferably, rotor mast 25 may be tilted in forward and rearward directions relative to fuselage 13. The blades of rotor 27 are weighted at their tips by weights for increasing stiffness at high rotational speeds and for creating inertia. Each blade of rotor 27 may have a shell that encloses a longitudinal twistable carbon fiber spar (not shown). The spar is continuous through the shell and attaches to the shell at approximately 40 percent of its radius. Other rotor constructions are possible. Each blade of rotor 27 is pivotal to various collective pitches about a centerline extending from rotor mast 25.

A forward thrust device, which in this example is a single propeller 29, is mounted on a rear portion of fuselage 13 and faces rearward. Rudders 21 are positioned aft of propeller 29 in a region that receives a discharge or prop blast from propeller 29. Even when aircraft 11 is not moving forward, part of the airstream from propeller 29 flows past each rudder 21. Propeller 29 may have a continuous carbon fiber spar (not shown) that runs from blade tip to blade tip. The carbon fiber spar is twistable inside a shell of propeller 29 to vary the collective pitch. Other devices and arrangements to provide forward thrust to aircraft 11 are possible.

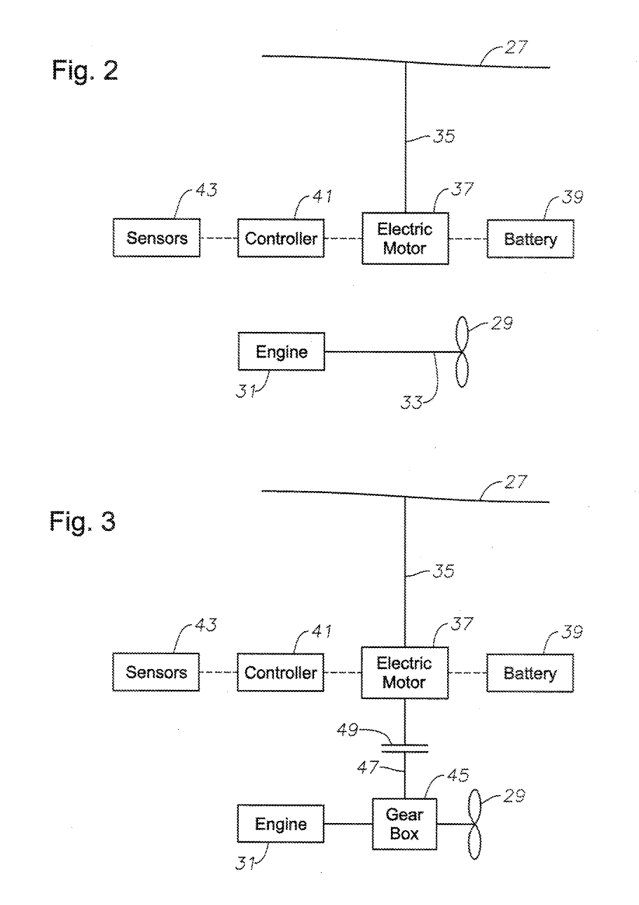

FIG. 2 schematically illustrates a power source 31 within fuselage 13 that drives propellers 29. Power source 31 may include a variety of engines, including gas turbine engines. The terms “power source” and “engine” may be used interchangeably herein. Power source 31 has an output drive shaft 33 that may lead directly to propeller 29, particularly if power source 31 is a gasoline powered internal combustion engine. If power source 31 is a gas turbine engine, a gear arrangement between output drive shaft 33 and propeller 29 would normally be required because of the much higher rotational speed of a gas turbine engine than propeller 29.

A rotor drive shaft 35 extends upward from fuselage 13 within rotor mast 25 (FIG. 1) to rotor 27. An electric motor 37 is coupled to rotor drive shaft 35 for applying torque to rotor drive shaft 35. Electric motor 37 may be a variety of types, and preferably is a variable speed type. Electric motor 37 may be connected directly to rotor drive shaft 35 or connected by a mechanism employed to release engagement of electric motor 37 when it is not being powered to rotate rotor 27. If necessary, electric motor 37 can be operated as a generator, retarding the rotational speed of rotor 27.

In the embodiment of FIG. 2, there is no connection between engine output shaft 33 and rotor drive shaft 35, thus all torque applied to rotor drive shaft 35 must come from electric motor 37. In the embodiment of FIG. 2, electric motor 37 has enough capacity to pre-rotate rotor 27 to a selected liftoff rotational speed while aircraft 11 is still on ground. That pre-rotational liftoff speed may be in a range from 300 to 400 rpm. A battery 39 supplies power to electric motor 37. Battery 37 may be charged by engine 31 or some other method.

A controller 41 controls electric motor 37, such as by controlling the power provided from battery 39. A number of flight condition sensors 43 are linked to controller 41. These sensors 43 may include ones that sense the following: airspeed; angle of attack of wings 15; torque applied to rotor drive shaft 35; lift provided by rotor 27; and rotational speed of rotor drive shaft 35. Other conditions may also be sensed. Controller 41 includes a processor that computes a desired rotational speed or torque to be applied to rotor drive shaft 35 by electric motor 37 depending upon the flight conditions sensed.

In operation of the embodiment of FIG. 2, for take-off and while still on the ground, electric motor 35 will apply torque to rotate rotor 37 up to a selected liftoff rotational speed while the collective pitch is at or near zero. Meanwhile, engine 31 will rotate propeller 29 while the propeller collective pitch remains near zero. The pilot applies the brakes. When rotor 27 reaches the full liftoff speed, either the pilot or controller 41 increases the collective pitches on rotor 37 and propeller 29 and releases the brakes. Aircraft 11 will accelerate forward and become airborne. The weighted tips of rotor 27 provide considerable momentum to continue rotating rotor 27. Controller 41 could be programmed to cease powering electrical motor 37 at liftoff. However, preferably electrical motor 37 continues to apply torque to rotor 27 after liftoff, although the rotational speed of rotor 27 will decay. As aircraft 11 gains speed, the pilot or controller 41 will begin tilting rotor mast 25 aft, which causes an airstream to flow from the lower side through rotor 27. Rotor 27 will begin auto-rotating in response to the airstream. Wings 15 increasingly provide lift for aircraft 11 as the forward speed increases. Controller 41 gradually reduces the collective pitch of rotor 27 and also gradually reduces the torque applied to rotor 27 by electric motor 37.

While torque is being applied to rotor drive shaft 35 by electric motor 37 a counter torque is generated against fuselage 13. There is no tail rotor in the embodiment shown. The pilot will orient rudders 21 to prevent fuselage 13 from spinning in an opposite direction to rotor 27. While still at slow forward speed, the prop blast over rudders 21 resists this counter torque.

At a steady state cruising speed, the collective pitch of rotor 27 will be at or near zero and the tilt of rotor mast 25 placed so that rotor 27 will be auto-rotating at a slowed speed, such as 100 to 200 rpm. Controller 41 may control electric motor 37 so that it will not be supplying any torque to rotor drive shaft 35. Under these conditions, rotor 27 supplies very little of the lift for aircraft 11.

Occasions may arise during flight that require rotor 27 to rapidly increase its speed, without significantly increasing its collective pitch. For example, turbulence encountered during cruise flight may result in a loss in some of the lift provided by wings 15. Increasing the collective pitch and tilt of rotor 27 would increase the speed of rotor 27, however, these steps could result in excessive flapping of the blades of rotor 27. Instead, when sensing a need for more lift to be provided by rotor 27, controller 41 will cause electric motor 37 to begin applying torque to rotor drive shaft 35, rapidly increasing the rotational speed of rotor 27. Controller 41 may decrease and completely cut off the torque supplied by electric motor 27 once the conditions merit. A similar need for a rapid increase in the rotational speed of rotor 27 would occur in the event engine 31 fails.

During a short landing, as the forward airspeed of aircraft 11 declines, wings 15 will supply less lift. Rotor 27 may be tilted and the collective pitch increased to provide more of the lift. If desired, controller 41 may cause electric motor 41 to apply torque to rotor shaft 35 during landing to augment the rotational speed caused by auto-rotation and control the rotor speed.

In the embodiment of FIG. 3, the same numerals are used for common components. In this embodiment, a gear box 45 is connected between the output shaft 47 of engine 31 and propeller 29. A clutch 49 connects between electric motor 37 and gear box 45. When clutch 49 is engaged, engine 31 will supply torque to rotor shaft 35. When clutch 49 is disengaged, controller 41 may cause electric motor 37 to supply torque to rotor drive shaft 35. The arrangement of FIG. 3 is particularly useful when engine 31 is a gas turbine engine. A gas turbine engine typically cannot supply torque until the rpm of the engine is at least 50% of its operating rpm.

In the FIG. 3 embodiment, for a short take-off, electric motor 37 will be sized so that it can pre-rotate rotor 37 without assistance up to a selected fraction of its liftoff rpm. For example, electric motor 37 may have the capacity to rotate rotor 37 to up about 150-200 rpm, if the selected pre-rotation lift off speed is 300-400 rpm. Once electric motor 37 reaches the fractional speed, clutch 49 is engaged so that engine 31 will spin rotor 27 on up to the selected pre-rotational lift off speed. Electric motor 37 could remain engaged after clutch 49 engages engine 31.

Once the pilot initiates liftoff, clutch 49 disengages engine 31 and the rotational speed of rotor 27 begins declining. Controller 41 may continue to cause electric motor 37 to apply torque until steady state forward flight conditions occur. Controller 41 may control the torque input of electric motor 37 to rotor shaft 35 in the same manner as in the embodiment of FIG. 2.

The first embodiment eliminates a need for a clutch between the engine and the propeller. If the engine is an internal combustion type, a gear box may be eliminated. In the second embodiment, the electric motor pre-rotates the rotor to a selected fraction of the liftoff rotational speed, at which time the engine will be engaged to complete the pre-rotation. In both embodiments, the electrical motor can be used during flight for increasing the speed of rotation rapidly if needed.

While the disclosure has been shown in only two of its forms, it should be apparent to those skilled in the art that it is not so limited but is susceptible to various changes without departing from the scope of the invention.

1. A rotor aircraft, comprising:
an engine;
a propeller driven by the engine to provide forward thrust to the aircraft;
wings for providing lift while in forward flight;
a rotor having a rotor drive shaft and mounted for selectively providing lift; and
an electric motor for selectively applying torque to the rotor drive shaft.

2. The rotor aircraft according to claim 1, wherein the electric motor comprises the sole source for applying torque to the rotor drive shaft.

3. The rotor aircraft according to claim 1, further comprising:
a clutch connected between the engine and the rotor drive shaft, for selectively engaging and disengaging the engine from the rotor drive shaft; and
wherein the clutch is located such that the electric motor is able to supply torque to the rotor drive shaft while the clutch is disengaged.

4. The rotor aircraft according to claim 1, wherein the electric motor is sized to supply all of the torque to pre-rotate the rotor to a selected liftoff rotational speed prior to liftoff of the aircraft.

5. The rotor aircraft according to claim 1, wherein the aircraft further comprises:
at least one rudder positioned within a prop blast region of the propeller; and
wherein the rudder is sized to counter torque applied by the electric motor to the rotor drive shaft while the aircraft is airborne.

6. The rotor aircraft according to claim 1, further comprising:
sensors for sensing flight conditions of the aircraft; and
a controller that controls the electric motor while the aircraft is airborne in response to input from the sensors.

7. The rotor aircraft according to claim 1, wherein:
the wings are capable of providing substantially all of the lift required during forward flight at a cruise speed;
the rotor is capable of being positioned to provide substantially zero lift and auto-rotate due to air flowing through the rotor at the cruise speed; and wherein the aircraft further comprises:
sensors for sensing flight conditions of the aircraft; and
a controller that selectively causes the electric motor to cease applying torque to the rotor drive shaft during autorotation at cruise speed and causes the electric motor to apply torque to the rotor drive shaft during flight if the sensors indicate additional rotor speed is needed.

8. The rotor aircraft according to claim 1, further comprising:
a controller that selectively causes the electric motor to cease applying torque to the rotor drive shaft once the forward airspeed is sufficient for the wings to provide substantially all of the lift required.

9. The rotor aircraft according to claim 1, further comprising:
a clutch connected between the engine and the rotor drive shaft for selectively engaging and disengaging the engine from providing torque to the rotor drive shaft; wherein
the clutch is located such that the electric motor is able to supply torque to the rotor drive shaft while the clutch is disengaged;
the electric motor is sized to pre-rotate the rotor prior to lift off to a selected fraction of a pre-rotation liftoff speed while the clutch is disengaged; and
when reaching the selected fraction, the clutch is engageable to enable the engine to apply torque to the rotor drive shaft to reach the pre-rotation liftoff speed.

10. A rotor aircraft, comprising:
an engine having an output shaft;
a propeller driven by the engine to provide forward thrust to the aircraft;
wings for providing lift while in forward flight,
a rotor having a rotor drive shaft and mounted for selectively providing lift;
an electric motor coupled to the rotor drive shaft for applying torque to the rotor drive shaft;
the electric motor being sized to supply all of the torque to pre-rotate the rotor to a selected speed prior to lift off of the aircraft;
the wings being capable of providing substantially all of the lift required during forward flight at a cruise speed;
the rotor being capable of being trimmed to provide substantially zero lift and auto-rotate due to air flowing through the rotor at the cruise speed;
sensors for sensing flight conditions of the aircraft; and
a controller that selectively causes the electric motor to cease applying torque to the rotor drive shaft during autorotation at cruise speed and causes the electric motor to apply torque to the rotor drive shaft if the sensors indicate additional rotor speed is needed.

11. The rotor aircraft according to claim 10, wherein the electric motor comprises the sole source for applying torque to the rotor drive shaft.

12. The rotor aircraft according to claim 10, further comprising:
a clutch between the output shaft of the engine and the rotor drive shaft, for selectively engaging and disengaging the engine from providing torque to the rotor drive shaft; and
wherein the clutch is located such that the electric motor is able to supply torque to the rotor drive shaft while the clutch is disengaged.

13. The rotor aircraft according to claim 12, wherein:
the electric motor is sized to supply all of the torque to pre-rotate the rotor to a selected fraction of a pre-rotation liftoff speed prior to liftoff of the aircraft; and
the clutch being engageable while at the selected fraction to cause the engine to pre-rotate the rotor to the pre-rotation liftoff speed.

14. The rotor aircraft according to claim 10, wherein the aircraft further comprises:
at least one rudder positioned within a prop blast region of the propeller; and
wherein the rudder is sized to counter torque applied by the electric motor to the rotor drive shaft while the aircraft is airborne.

15. A method of flying a rotor aircraft having an engine, a propeller driven by the engine, wings, and a rotor having a rotor drive shaft, comprising:
(a) coupling an electric motor to the rotor drive shaft;
(b) applying torque from the electric motor to the rotor drive shaft to pre-rotate the rotor to a selected speed prior to liftoff of the aircraft;
(c) rotating the propeller with the engine while the rotor is pre-rotating to cause liftoff of the aircraft; and
(d) once a selected airborne speed is reached, ceasing to applying torque from the electric motor to the rotor drive shaft.

16. The method according to claim 15, wherein step (d) further comprises:
causing the rotor to auto-rotate due to air flow through the rotor before ceasing to apply torque from the electric motor to the rotor drive shaft.

17. The method according to claim 15, wherein step (d) further comprises:
at a selected cruise speed, positioning the rotor to cause the rotor to auto-rotate at a minimum rotational speed with no torque being applied by the electric motor; and
if flight conditions warrant a higher rotor speed than the minimum rotational speed, again causing the electric motor to apply torque to the rotor drive shaft.

18. The method according to claim 15, wherein:
the aircraft has a rudder positioned within a prop blast region; and
step (d) further comprises positioning the rudder after the liftoff to counter the torque applied by the electric motor.

19. The method according to claim 15, wherein step (b) comprises supplying from the electric motor all of the torque required to reach a selected liftoff rotational speed.

20. The method according to claim 15, wherein:
step (a) further comprises connecting the engine to the rotor drive shaft via a clutch;
step (b) comprises while the clutch is disengaged, rotating the rotor with the electric motor up to a selected fraction of a liftoff rotational speed; then
engaging the clutch and applying torque from the engine to the rotor drive shaft to rotate the rotor up to the liftoff rotational speed.
